(19) United States
(12) Patent Application Publication
(10) Pub. No.: US 2010/0125566 A1
(43) Pub. Date: May 20, 2010

(54) SYSTEM AND METHOD FOR CONDUCTING A PATENT SEARCH

(75) Inventors: Andrew Gibbs, Yuba City, CA (US); Stephanie A. Gibbs, Yuba City, CA (US)

Correspondence Address: WILMERHALE/BOSTON, 60 STATE STREET, BOSTON, MA, 02109, US

(73) Assignee: PATENTCAFE.COM, INC., SACRAMENTO, CA (US)

(21) Appl. No.: 12/272,808

(22) Filed: Nov. 18, 2008

(51) Int. Cl. G06F 7/06; G06F 17/30; G06F 7/00

(52) U.S. Cl. 707/722; 707/E17.014

(57) ABSTRACT

A system for creating a patent search report comprising a case management subsystem for receiving patent-related information from a patent document and creating the patent search report, a search subsystem for searching at least one database using the patent-related information as a search query, and a classification subsystem for classifying the patent-related information according to one or more international classification systems based on the searching of the at least one database.

### CROSS-REFERENCE TO RELATED APPLICATIONS

This application is based upon and claims the benefit of priority from Provisional Application No. 60/988,389 filed Nov. 15, 2007, the entire contents of which are incorporated herein by reference.

### FIELD

This present disclosure relates generally to patent searching, and in particular but not exclusively, relates to a system and method for automating various operations that are normally conducted manually by patent professionals and inventors during the preparation of a patent prior art search report and the creation of a final patent search report.

### BACKGROUND

A new invention must meet certain criteria in order to be considered patentable. Under these criteria, an invention must be novel, non-obvious to one skilled in the art, and useful. In order to determine whether an invention is novel or non-obvious, inventors and their patent agents or attorneys typically conduct a search on a database containing existing United States and foreign patents or published patent applications, technical journal articles, specialized databases for genomic sequences or chemical structures, as well as other technical or scientific references, to determine whether the invention was previously patented or disclosed by another. If the search results in the discovery of a document that discloses the same invention, the present invention may not be patentable. The study of these earlier references is called a prior art search. Patent examiners at the US Patent and Trademark Office (USPTO) conduct a prior art search on every newly submitted patent application to determine whether the claimed invention is patentable over the prior art.

Prior art searches are also conducted for reasons other than determining patentability. Professionals in the intellectual property industry routinely search prior art databases to investigate the potential infringement of a product on a granted patent, or to search for prior art that may be used to argue the potential invalidity of a granted patent.

A person conducting a comprehensive prior art search typically follows a complex, iterative process of searching prior art databases, usually through the use of a computer connected to a database and search interface, recording the search queries used to conduct the search, continuing to refine the search, copying of additional information from the search results list, for example, the list of references most closely related to the new invention being searched, typing a list of explanations that discuss differences between the new invention and prior art references found during the search, and compiling all of the search information into a single report for delivery to the inventor, an attorney, or to the USPTO in association with a patent application. Since a search is conducted on a new invention prior to filing for a new patent application, which will be examined by a patent office examiner at some later date, the final work product is typically referred to as a Pre-examination Search Report.

The compilation of the report requires the report preparer to submit the information contained in the report following a specified structure that clearly presents the details of the search including, but not necessarily limited to a report section specifically identifying the location within each prior art reference where the reference discloses art similar to the claimed invention, a report section showing where each claim in the patent application is supported within the written description of the application, a section identifying the databases that were used for the search, and one or more sections including various statements related to the search, such as a precise statement of utility for each independent claim of the patent application, statements showing support for each means-plus-function, or step-plus-function claim limitation, a statement of small entity status if necessary, and a variety of other statements specifically relating to the search report, invention or related patent application.

The searcher, or possibly an administrative support person, will typically prepare a number of pre-formatted forms to accompany the submission of the Pre-examination Search Report to the patent office. In the United States, the forms typically prepared for submission to the USPTO include a transmittal form, an Information Disclosure Statement that lists prior art references and various petitions or other patent office forms that would typically accompany the patent application and search report.

It can be readily understood from the previous description that search report preparation is a complex, time-consuming process that relies primarily on manual labor. The process also requires the searcher or preparer to exercise extreme diligence in following each step of the workflow process, usually in sequence, to ensure that the report is complete, that no steps are missed, and that the final Pre-examination Search Report and all required forms for report submission are properly completed. Missed steps, or missing information required to be in the search report could result in the patent office's rejection of the search report in its entirety.

Various software and patent search engine providers have attempted to automate various steps of the search report process. For example, LexisNexis® PatentOptimizer™ Service was developed specifically to aid in the drafting and analysis of patent applications and granted patents. This software deconstructs the claims of a patent to show frequency of keywords used in claims construction, and shows prior art references where the same keywords appear in the claims of referenced prior art documents. However, this solution is more appropriately used to assist an attorney in drafting the claims of a new patent application rather than assisting in the actual prior art search or preparation of a Pre-examination Search Report. In combination, PatentHunter, a software tool that retrieves patent documents based on a keyword search, and PatentWizard®, a software tool that assists in compiling a patent application, provides a rudimentary level of automation, but this combination is primarily limited to the creation of a provisional patent application, and does not address Pre-examination Search Reports. PatentPro® and PatentEase® are two software applications that automate the compilation of non-provisional patent applications, but they do not provide a means to conduct a prior art search, and do not assist in the preparation of a Pre-examination Search Report. Search engine providers such as Delphion do provide elementary software tools that may assist a searcher to prepare a search report, such as the recording of search queries used in the prior art search, or the saving of prior art references that will be later included in the Information Disclosure Statement that accompanies the Pre-examination Search Report. Delphion also provides a utility called Workfiles; however, Delphion provides no means of automating the process of searching, classifying a patent application or patent claims, or compiling search reports or standardized forms.

It can be readily seen that there is not a lack of attempts to automate the workflow process of searching patents, creating search reports, or preparing standardized forms, and such attempts have been only marginally successful in semi-automating a very limited number of any of the steps encountered in the overall Pre-examination Search Report workflow process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is an exemplary diagram showing one variation of the workflow automation process in an embodiment.

FIG. 2 is an exemplary diagram showing a computer system in an embodiment.

FIG. 3 is an exemplary flowchart showing a process of creating a new case in an embodiment.

FIG. 4 is an exemplary flowchart and simulated computer screen showing a process to edit case information in an embodiment.

FIG. 5 is an exemplary flowchart and simulated computer screens showing a process to conduct a prior art search, and to review the search results list in an embodiment.

FIG. 6 is an exemplary flowchart and simulated computer screen showing a process to enter information related to a prior art reference in an embodiment.

FIG. 7 is an exemplary flowchart and simulated computer screen showing a process of adding additional prior art references in an embodiment.

FIG. 8 is an exemplary flowchart and simulated computer screen showing a process of searching a patent specification for references that show support for a claim in an embodiment.

FIG. 9 is a flowchart illustrating a process for identifying classifications for patent claims in an embodiment.

### DETAILED DESCRIPTION

Various aspects of specific embodiments are disclosed in the following description and related drawings. Alternate embodiments may be devised without departing from the spirit or the scope of the present disclosure. Additionally, well-known elements of exemplary embodiments will not be described in detail or will be omitted so as not to obscure relevant details. Further, to facilitate an understanding of the description, a discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments” is not exhaustive and does not require that all embodiments include the discussed feature, advantage or mode of operation.

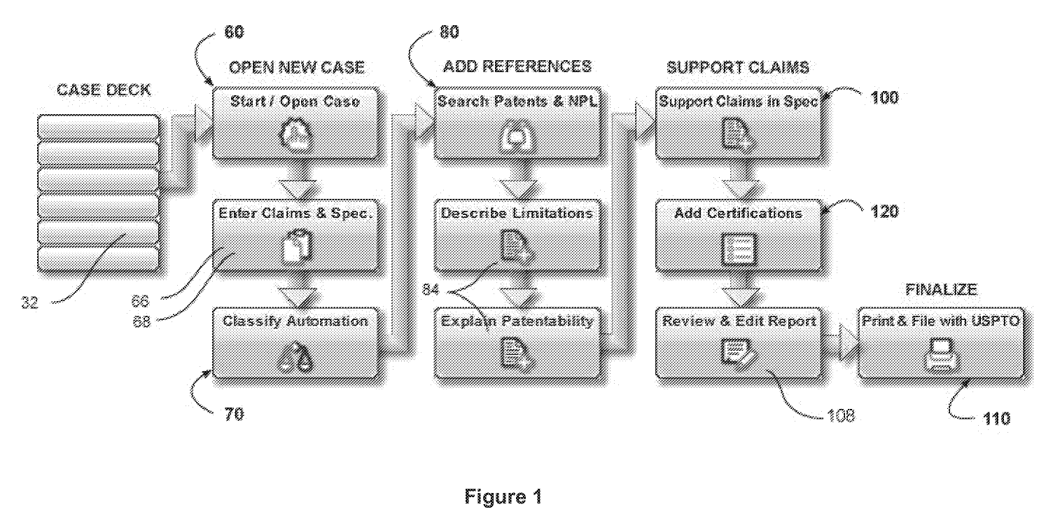

FIG. 1 illustrates an embodiment of a workflow automation process executed on a computer software system. A new search report is created by first opening a new case 60, or opening an existing case from the collection of previously created cases contained in a case deck 32 collection of the user's cases. The computer software system provides for the entry into a member database of the text of the specification and claims 68 of a patent for which a search report will be prepared. The computer software system provides for the automatic classification 70 of the claims, identifying the most closely related US patent classification for each claim. The computer software system provides for the automation of a patent prior art search 80 in one or more databases containing prior art documents. The computer software system includes a plurality of text input screens 84 that allow the user to enter descriptions and explanations of related prior art references. Continuing along a workflow process, the computer software system provides for the automated analysis 100 of a patent specification to identify instances in the specification that show support for each or any of the patent claims. The computer software system provides for adding certifications 120 or statements related to the preparation of a search report, or more generally, to the patent application. The computer software system includes a means to review and edit information 108 contained in a preliminary search report prior to finalizing and printing 110 of the final Pre-examination Search Report.

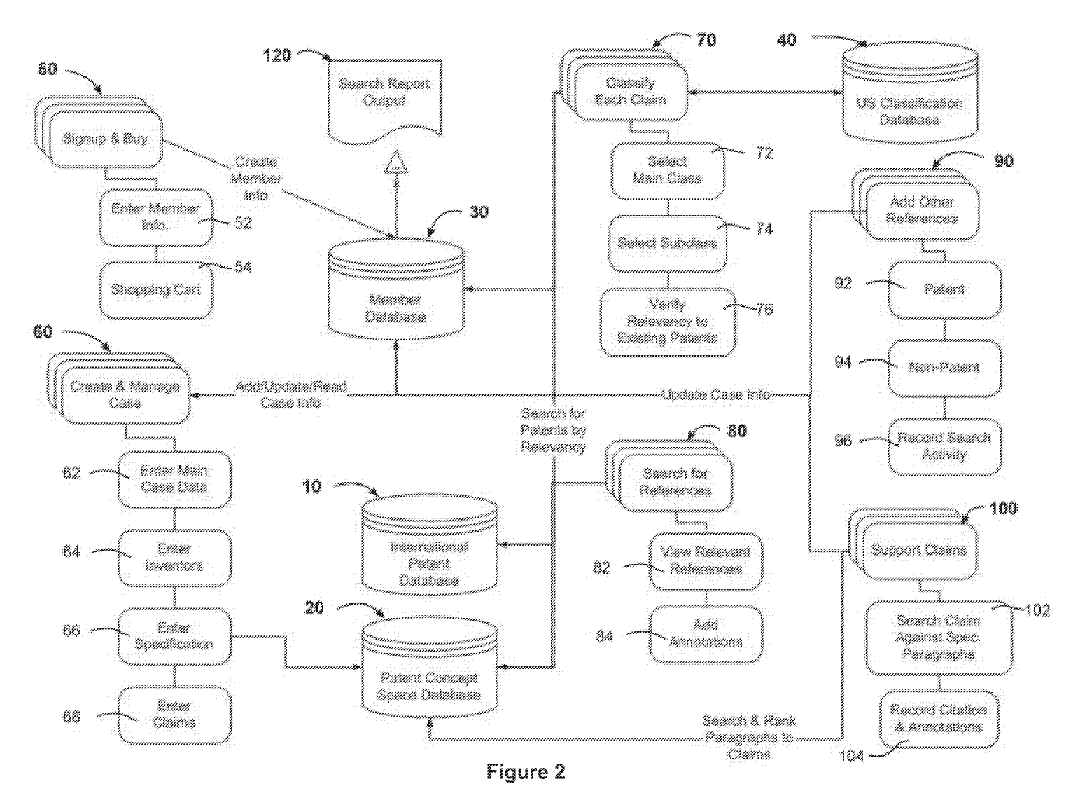

FIG. 2 illustrates subsystems of the computer software system shown in FIG. 1 which include an international patent database 10 containing U.S. and foreign patent documents. Additionally, the system provides for a plurality of databases that may contain granted patents, published patent applications, non-patent documents, or other references that may be useful to conducting a prior art search. A second database 20 is a patent concept space database comprising vectors that represent the documents being searched. The concept space is created using a Latent Semantic Analysis (LSA) or Latent Semantic Index (LSI), natural language processing techniques that analyze relationships between a set of documents and the terms they contain by producing a set of concepts related to the documents and terms. The patent concept space database 20 is a semantic representation of the patent documents contained in the international patent database 10. In one embodiment, a database 40 contains a library of definitions for each U.S. patent classification and sub-classification included in the U.S. Patent Classification system. In an alternative embodiment, one or more databases are provided that contain various libraries of definitions from international classification systems, by way of example, the library of definitions for International Patent Classifications (IPC) or the European Classification System (ECLA). The computer software system also provides a member database 30 that is used to store records and information for each user of the system. The records may include, but of course are not limited to, a member's personal account information, a deck or collection of cases which have been previously created, or other information about, or managed by the member.

The computer system provides for the purchase of access to the system by means of an electronic commerce interface 50 through which a member enters their personal and account information 52, and pays for access to the system through a billing method or web-based shopping cart 54.

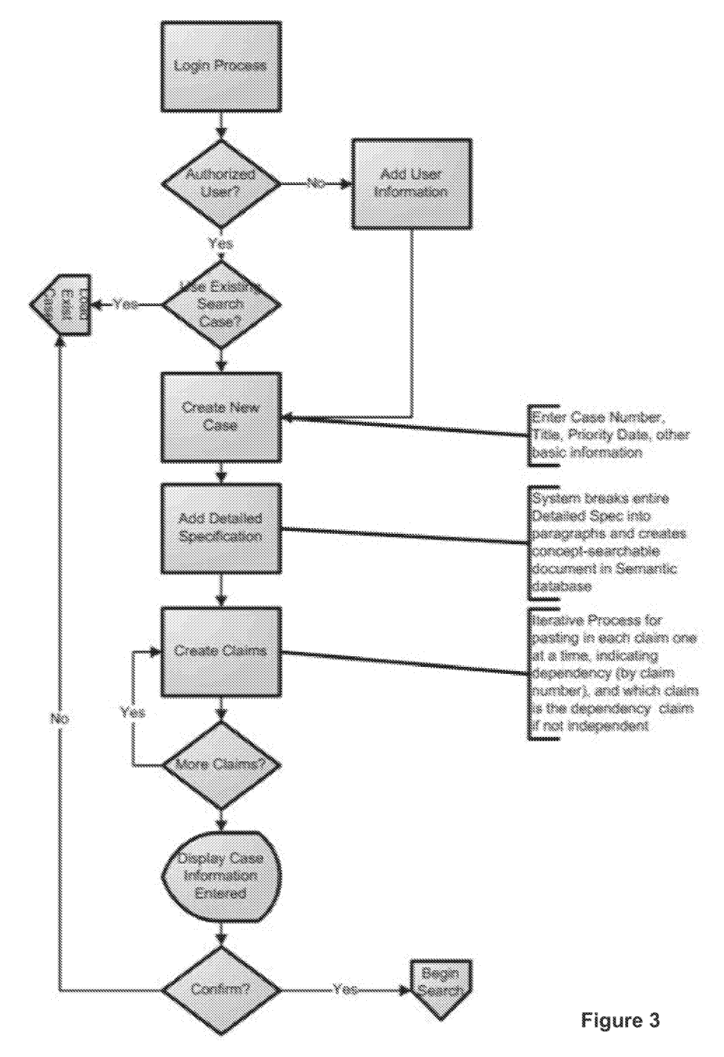

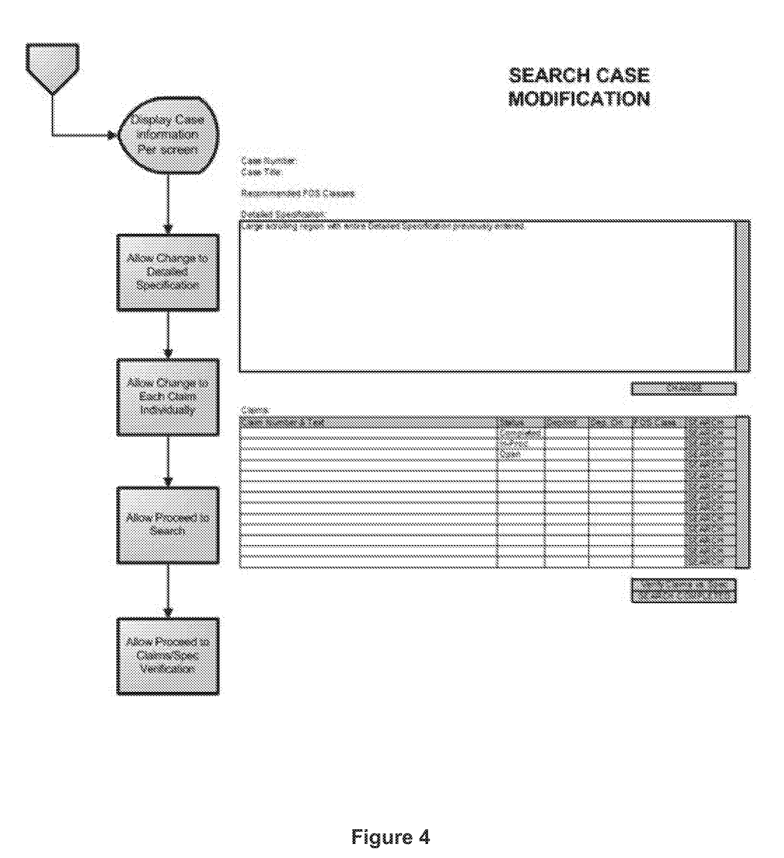

In an exemplary embodiment, a subsystem is provided in the computer software system to create and manage one or more cases 60 based on user-entered case data 62. The case data 62 may include docket number, patent application filing date, priority date for the application, applicant name, entity type, client name, patent or patent application title, serial number or patent application number, the name of the first named inventor and any other co-inventors 64, or other information particular to the present case for which a search report will be prepared. This subsystem further provides text entry screens to allow an end-user to enter the text of the specification of a patent or patent application 66, and another text entry screen used for entering one or more claims of the patent or application 68. An embodiment of the process implemented by the subsystem to create and manage a case is disclosed in FIG. 3 and an embodiment of a process and representative computer screen for user input to edit and save changed case information is disclosed in FIG. 4.

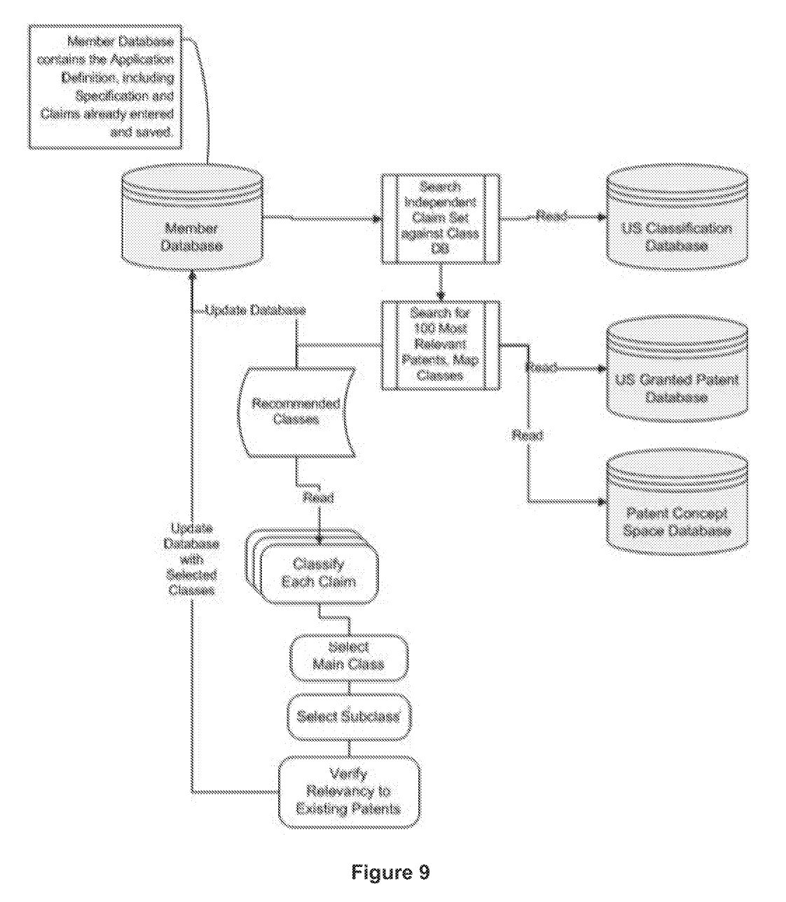

FIG. 9 illustrates an exemplary embodiment of a process used in a classification system 70 for automating the identification of the most closely related U.S. patent classification for one or more claims. Those skilled in the art will understand that the classification system could just as well classify one or more claims according to the IPC, ECLA or other classification system. To establish the most closely related classification for each claim, the computer system automatically retrieves the text of the claim to be classified from the previously entered case information stored upon the member database 30, and uses the full text as a search query applied upon one or more of the classification database 40, the patent concept space database 20, or another appropriate database that may be a database of the computer system. The search query returns a set of results comprised of a relevancy-ranked list of US classifications most closely related to the claim included in the search query. In the normal workflow process, the user reviews the classification list and selects one or more main classifications 72 that the user believes most accurately reflect the subject matter of the claim. The computer system provides for refinement of the main classification by conducting a second search using as the search query a combination of the computer system automatically retrieving the text of the claim to be classified, and combining it with each of the main US classifications selected by the user 72, thereby creating a search query comprised of a boolean keyword and semantic concept query, known to those skilled in the art as an heuristic search query. The second search returns a set of results comprised of a relevancy-ranked list of US classifications and sub-classifications most closely related to the claim included in the search query. In the normal workflow process, the user reviews the classification/sub-classification list and selects one or more class/subclass combinations 74 that the user believes most accurately reflect the subject matter of the claim. The class / subclass combination is identified as the Field of Search to be later used as a Boolean keyword for conducting a prior art search. As an additional step, the classification system automatically presents previously granted or published prior art patents or patent applications most closely related to the selected class/sub-combinations 74. This process is used to verify the relevancy of the selected class/subclass for the claim being classified 76 to patent documents previously classified by the patent office according to one of more of the selected class/subclass combinations.

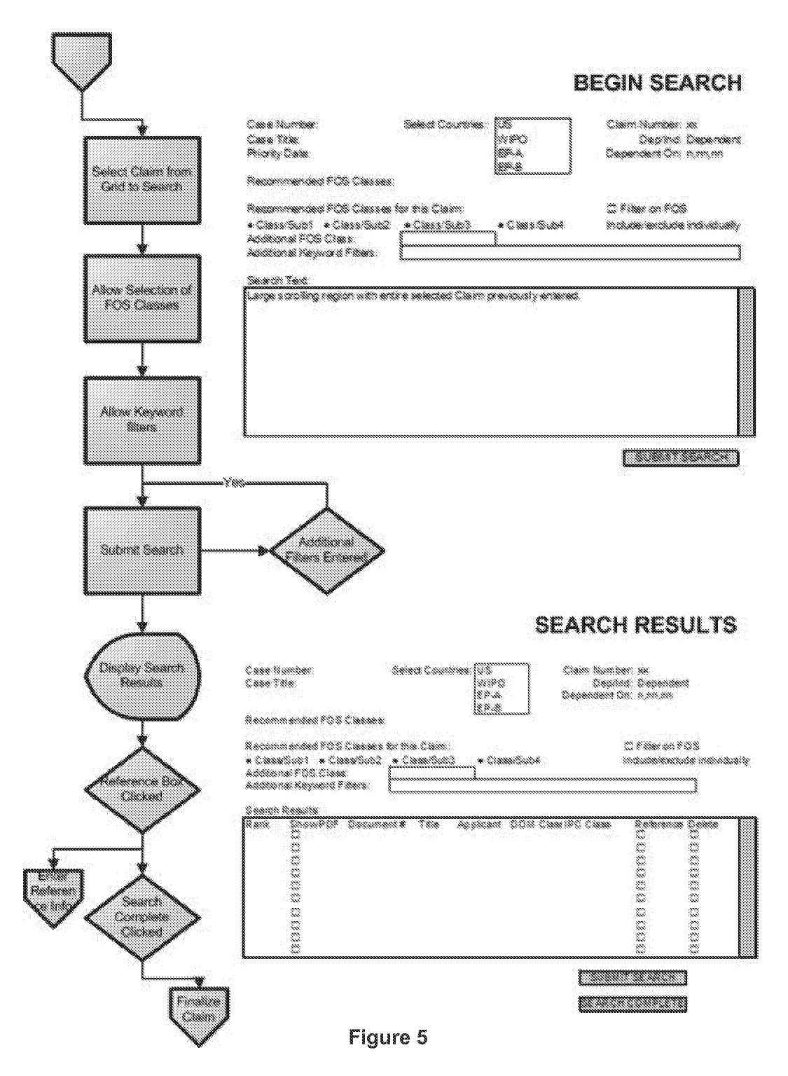

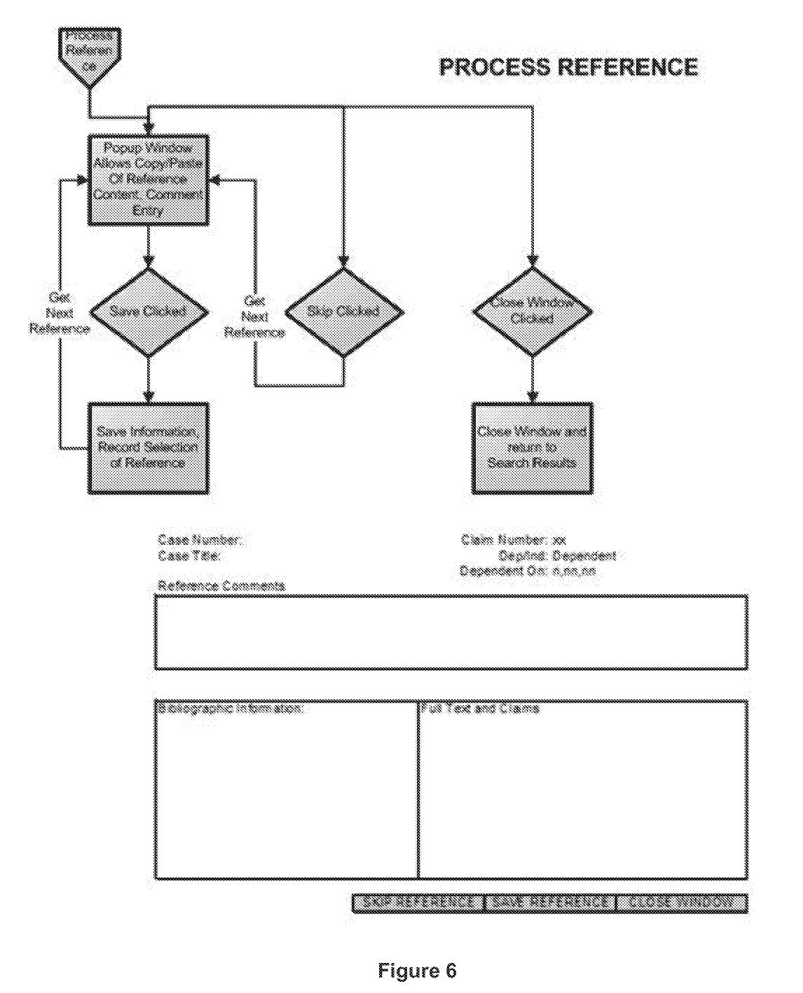

The exemplary embodiments include a subsystem 80 to automate the prior art search leading to the identification of the most closely related prior art references for each of one or more claims. To establish the most closely related prior documents for each claim, the computer system automatically retrieves the text of the claim to be searched from the previously entered case information stored in the member database 30, and uses the full text as a search query applied to the patent concept space database 20, or another appropriate database that may be accessible from or within the computer system. Those skilled in the art will understand that a prior art search system can also include a non-patent concept space database representing a database of patents issued from other patent authorities such as the European Patent Office of the Japanese Patent Office, or non-patent literature or other prior art document collection. The search query returns a results set comprised of a relevancy-ranked list of US granted patents, published US patent applications, and published patent documents from the European Patent Office (EPO), the World Intellectual Property Organization (PCT applications), or other patent issuing authorities. The prior art documents most closely related to the claim included in the search query are returned. In the normal workflow process, the user reviews the ranked list of references, and selects each one to review 82 in more detail. When the user desires to view more detailed information of the reference, additional information is presented. In the case where the referenced document is a patent, the information may include patent bibliographic information such as patent number, U.S. patent classification, IPC, filing date, issue or publication date, priority document numbers, references, inventor name(s), applicant/assignee name, patent examiner name, patent attorney or agent, full text of the abstract, detailed specification, claims, drawings, or other information that may be contained on the patent document. When the researcher selects a reference to be included in the Pre-examination Search Report, the researcher reviews the reference document in detail to identify the specific sections within the referenced document that disclose a patent claim limitation undergoing the search. The prior art search system provides a text entry screen allowing the researcher to enter annotations 84 relating to the reference, including but not necessarily limited to specifying the location of a disclosure within the reference related to the limitation of the claim, the entry of an explanation of patentability of the claim over the disclosure of the reference, and the entry of a statement of utility. Upon completing the addition of annotations to the reference, the user may view other references related to the same claim, and repeat the process. Further, the process just described would be repeated for each claim for which a prior art search is desired. An embodiment of a process for performing a prior art search using the subsystem 80 is disclosed in FIG. 5, and yet another embodiment of the method and a representative user interface for adding annotations related to a reference 84 is disclosed in FIG. 6.

An alternative embodiment of the prior art search subsystem 80 provides for the computer system to automatically create an Heuristic search query comprising retrieved text of the claim to be searched from the previously entered case information stored upon the member database 30, a Boolean operator AND, and the Field of Search classification previously identified in the classification system. The results list obtained from the Heuristic search query is comprised of a relevancy-ranked list of US granted patents, published US patent applications, and published patent documents from the European Patent Office (EPO), the World Intellectual Property Organization (PCT applications), or other patent issuing authorities. These documents represent the prior art which is most closely related to the claim included in the search query. In the normal workflow process, the user reviews the ranked list of references, and selects each one to review 82 in more detail. When the user desires viewing more detailed information of the reference, additional information is presented. In the case where the referenced document is a patent, the information may include patent bibliographic information such as patent number, U.S. patent classification, IPC, filing date, issue or publication date, priority document numbers, references, inventor name(s), applicant/assignee name, patent examiner name, patent attorney or agent, full text of the abstract, detailed specification, claims, drawings, or other information that may be contained on the patent document. When the researcher selects a reference to be included in the Pre-examination Search Report, the researcher reviews the reference document in detail to identify the specific sections within the referenced document that disclose a claim limitation undergoing the search. The prior art search system provides a text entry screen allowing the researcher to enter annotations 84 relating to the reference, including but not necessarily limited to specifying the location of a disclosure within the reference related to the limitation of the claim, the entry of an explanation of patentability of the claim over the disclosure of the reference, and the entry of a statement of utility. Upon completion of adding annotations to the reference, the user may view other references related to the same claim, and repeat the process just described. Further, the process just described would be repeated for each claim for which a prior art search is desired.

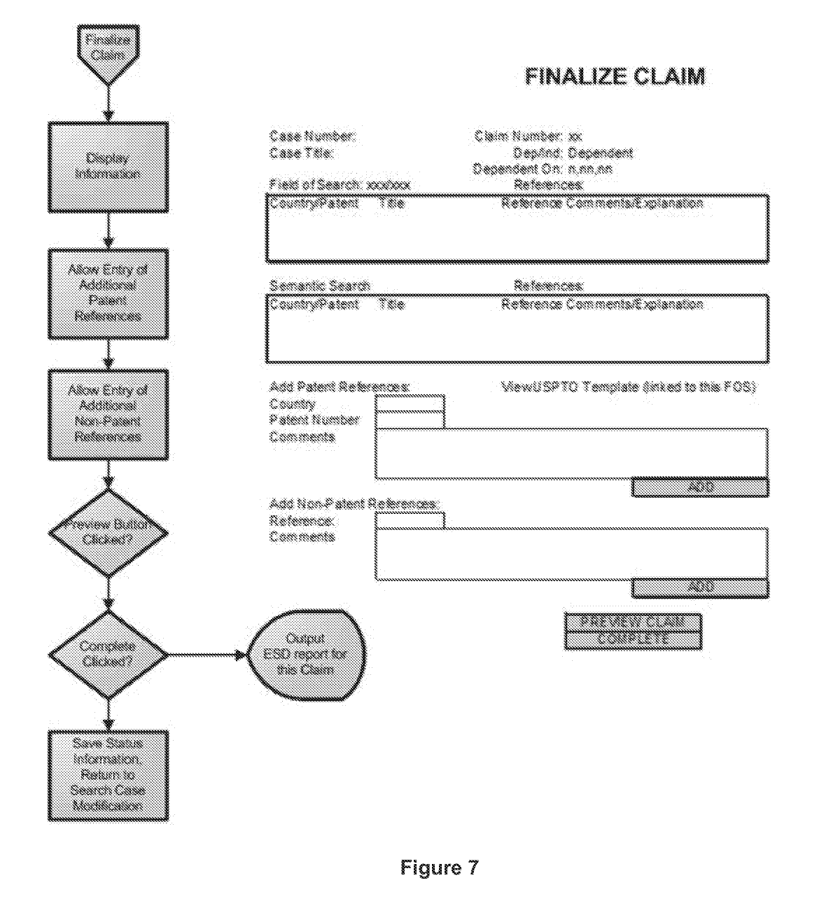

To those skilled in the art, it is evident that no single prior art database is likely to contain every possible prior art reference deemed relevant to the claims being searched. In order to allow references obtained from databases outside of the computer software system, or a reference simply known to the researcher, the exemplary embodiments include a subsystem that allows the user to add other references 90 into the Pre-examination Search Report. Text input screens are provided allowing for the addition of patent references 92, non-patent references 94, and to add a record of the search activity 96. Search activity conducted on a third party database includes, but is not limited to, the search query or search logic used in the search, the database service provider used for the search, the particular data files or document collections upon which the search was conducted, specific locations where limitations of the claims appear in the reference, explanations of patentability of the claims over the cited reference, and a concise statement of utility. Another embodiment of the computer software system allowing the addition of other references 90 is disclosed in FIG. 7.

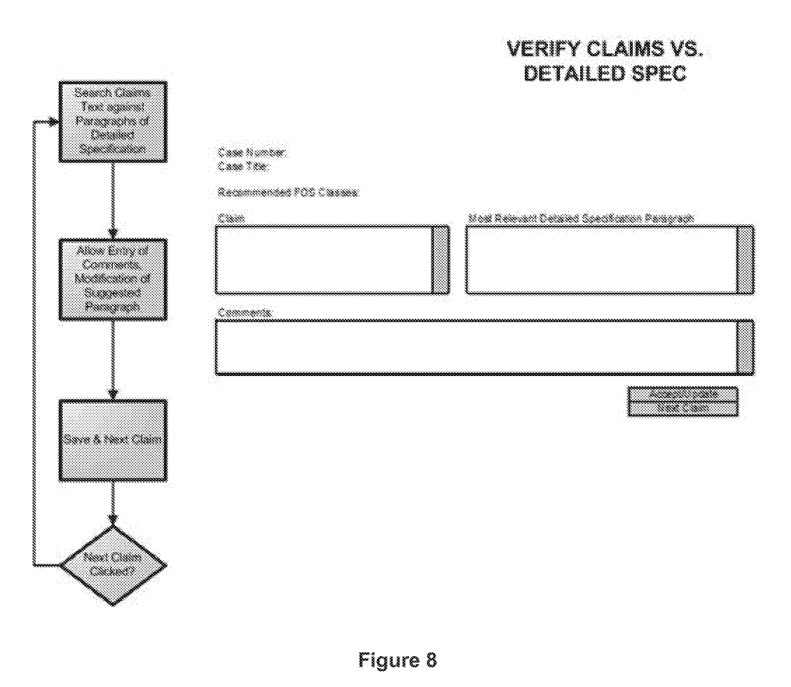

Yet another embodiment of the computer software system allows for the showing of support for the claims 100 being search by identifying each means-plus-function or step-plus-function claim element under 35 U.S.C. 112, Para. 6, and identifying where each limitation of the claims 100 finds support under 35 U.S.C. 112, Para. 1. In automating the showing of support, the computer software system first retrieves and semantically indexes the text of the specification of the patent or patent application was previously entered as case information stored in the member database 30, and stores it as a temporary document in the patent concept space database 20. The computer software system divides the text of the specification into individual paragraphs, and indexes each paragraph as a pseudo document for later searching. The computer software system further retrieves the full text of each claim which was previously entered in the case information and stored in the member database 30. Continuing the automated workflow process, the computer software system conducts a search of the specification to identify the paragraphs that most closely relate to, and support each claim by a process comprised of applying the text of each claim to be searched as a search query 102 to paragraphs of the specification that are stored in the patent concept space database 20 as a temporary document. The search results list presents every paragraph of the specification ranked in descending order from the paragraph most closely related to and in support of the claim. The computer software system further provides for a text entry screen 104 into which the researcher may copy and paste, or manually enter the specific disclosure, or the location of the disclosure contained within the specification that supports the claim. An embodiment of the method and user interface implemented by the computer software system which allows the showing of support of the claims 100 in the specification is disclosed in FIG. 8.

Yet another embodiment of the computer software system provides for the creation of one or more reports 120 containing the information of one or more of the processes completed within the workflow process of the computer software system. By programmatically placing the case information contained in the member database 30 onto standardized or non-standardized preformatted forms, a researcher can quickly and easily create a final Pre-examination Search Report document and associated submittal forms ready for hardcopy printing or filing electronically through the USPTO EFS-web or other electronic filing system. Such reports may include, but are not limited to standardized forms required by the USPTO to accompany a search report or patent application, for example, PTO/SB/08A (05-07) Information Disclosure Statement By Applicant, PTO/SB/28 (04-07) Petition to Make Special Under Accelerated Examination Program, and standardized transmittal forms. Non-standardized forms may include, but are not limited to various forms such as a Pre-examination Search Record, Explanation of Patentability of the Claims Over The References, Statement of Utility, A Showing Of Support Of the Limitations of the Claims, forms containing attestations or certifications made by the searcher, preparer or inventors as may be desired, and other forms for organizing and presenting a Pre-examination Search Report.

As would be obvious to one skilled in the art, although much less efficient, and more manually intensive, a traditional Boolean keyword search process may be used to replace the automated Latent Semantic Analysis search process. The embodiments disclosed herein are not intended to limit the automated compiling of a final Pre-examination Search Report to the exclusion of a Boolean keyword search process, but to disclose the integrated classification, search and report generation process substantially as described by the present computer software system.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. A computer-implemented method for creating a patent search report, the method comprising:
receiving patent-related information related to a patent document;
searching at least one database using the patent-related information as a search query;
classifying the patent-related information according to one or more international classification systems; and
creating a patent search report based on the searching of the patent-related information and the classifying of the patent-related information.

2. The computer-implemented method of claim 1 wherein the patent document is a U.S. patent application.

3. The computer-implemented method of claim 1 wherein the patent document is a granted U.S. utility patent.

4. The computer-implemented method of claim 1 wherein the patent-related information is comprised of a first portion and a second portion, the first portion including a patent application specification and the second portion including at least one patent claim from the patent application.

5. The computer-implemented method of claim 4 wherein the searching of the at least one database is performed using the second portion of the patent-related information as the search query.

6. The computer-implemented method of claim 4 wherein the searching of the at least one database is performed using the second portion of the patent-related information and a field of search retrieved from a classification database as the search query.

7. The computer-implemented method of claim 1 wherein the at least one database is an international database including U.S. and foreign patent documents.

8. The computer-implemented method of claim 1 wherein the at least one database is a patent concept space database.

9. The computer-implemented method of claim 1 wherein the at least one database includes at least one of granted patents, published patent applications and non-patent documents.

10. The computer-implemented method of claim 8 wherein the patent concept space database comprises vectors created from use of a natural language processing technique.

11. The computer-implemented method of claim 10 wherein the natural language processing technique is Latent Semantic Analysis.

12. The computer-implemented method of claim 10 wherein the natural language processing technique is Latent Semantic Index.

13. The computer-implemented method of claim 1 wherein the receiving of the patent-related information further comprises opening a case file for management of the searching using the patent-related information, the classifying of the patent-related information, and the creation of the patent search report.

14. The computer-implemented method of claim 13 wherein the case file is a new case file in a member database.

15. The computer-implemented method of claim 13 wherein the case file is an existing case file in a member database created from a case deck collection including the patent document.

16. The computer-implemented method of claim 13 wherein the case file includes at least one of a docket number, a patent application filing date, a priority date for a patent application, a patent application serial number and a name of a first named inventor.

17. The computer-implemented method of claim 1 wherein the classifying of the patent-related information comprises:
retrieving at least one patent claim from the patent document;
using the at least one retrieved patent claim as the search query; and
searching at least one of a classification database and a patent concept space database using the search query.

18. The computer-implemented method of claim 1 wherein the international classification systems include at least one of the U.S. Patent Classification system, the International Patent Classifications (IPC) system and the European Classification System (ECLA).

19. The computer-implemented method of claim 1 wherein the creating of the patent search report comprises:
identifying a location of a disclosure in one or more reference documents retrieved from the searching of the at least one database using the patent-related information;
entering an explanation of patentability of at least one patent claim over the disclosure located in the one or more reference documents;
entering a statement of utility relating to the at least one patent claim; and
showing of support for the at least one patent claim in a specification of the patent document.

20. The computer-implemented method of claim 20 wherein the showing of support comprises:
semantically indexing a plurality of textual paragraphs in the specification;
retrieving the semantically indexed textual paragraphs;
applying as a search query the at least one patent claim to the retrieved, semantically indexed textual paragraphs; and
generating a rank-ordered results list of the textual paragraphs most semantically related to the at least one patent claim.

21. The computer-implemented method of claim 1 wherein the creating of the patent search report comprises:
identifying a location of a disclosure in one or more reference documents retrieved from the searching of the at least one database using the patent-related information;
entering an explanation of patentability of at least one patent claim over the disclosure located in the one or more reference documents; and
showing of support for the at least one patent claim in a specification of the patent document.

22. The computer-implemented method of claim 21 wherein the showing of support comprises:
semantically indexing a plurality of textual paragraphs in the specification;
retrieving the semantically indexed textual paragraphs;
applying as a search query the at least one patent claim to the retrieved, semantically indexed textual paragraphs; and
generating a rank-ordered results list of the textual paragraphs most semantically related to the at least one patent claim.

23. A system for creating a patent search report, the system comprising:
a case management subsystem for receiving patent-related information from a patent document and creating the patent search report;
a search subsystem for searching at least one database using the patent-related information as a search query; and
a classification subsystem for classifying the patent-related information according to one or more international classification systems based on the searching of the at least one database.

24. The system of claim 23 wherein the patent document is a U.S. patent application.

25. The system of claim 24 wherein the patent document is a granted U.S. utility patent.

26. The system of claim 24 wherein the patent-related information is comprised of a first portion and a second portion, the first portion including a patent application specification and the second portion including at least one patent claim from the patent application.

27. The system of claim 26 wherein the search query includes the second portion of the patent-related information.

28. The system of claim 26 wherein the search query includes the second portion of the patent-related information and a field of search retrieved from a classification database.

29. The system of claim 23 wherein the at least one database is an international database including U.S. and foreign patent documents.

30. The system of claim 23 wherein the at least one database is a patent concept space database.

31. The system of claim 23 wherein the at least one database includes at least one of granted patents, published patent applications and non-patent documents.

32. The system of claim 30 wherein the patent concept space database comprises vectors created from use of a natural language processing technique.

33. The system of claim 32 wherein the natural language processing technique is Latent Semantic Analysis.

34. The system of claim 32 wherein the natural language processing technique is Latent Semantic Index.

35. The system of claim 23 wherein the case management subsystem is operative to open a case file for management of the searching using the received patent-related information.

36. The system of claim 35 further comprising a member database, wherein the case file is a new case file in the member database.

37. The system of claim 35 further comprising a member database, wherein the case file is an existing case file in the member database created from a case deck collection including the patent document.

38. The system of claim 35 wherein the case file includes at least one of a docket number, a patent application filing date, a priority date for a patent application, a patent application serial number and a name of a first named inventor.

39. The system of claim 23 wherein the classification subsystem includes a classification database, the classification database storing a plurality of field of search classifications for at least one of the one or more international classification systems.

40. The system of claim 39 wherein the classification subsystem is operative to:
retrieve at least one patent claim from the patent document;
use the at least one retrieved patent claim as the search query; and
search at least one of the classification database and a patent concept space database using the search query.

41. The system of claim 23 wherein the international classification systems include at least one of the U.S. Patent Classification system, the International Patent Classification (IPC) and the European Classification System (ECLA).

42. The system of claim 23 wherein the case management subsystem is operative to:
enable an end-user to identify a location of a disclosure in one or more reference documents retrieved from the searching of the at least one database;
enable an end-user to enter on a first user interface an explanation of patentability of at least one patent claim over the disclosure located in the one or more reference documents;
enable an end-user to enter on a second user interface a statement of utility relating to the at least one patent claim; and
enable an end-user to show support for the at least one patent claim in a specification of the patent document.

43. The computer-implemented method of claim 42 wherein the showing of support comprises:
semantically indexing a plurality of textual paragraphs in the specification;
retrieving the semantically indexed textual paragraphs;
applying as a search query the at least one patent claim to the retrieved, semantically indexed textual paragraphs; and
generating a rank-ordered results list of the textual paragraphs most semantically related to the at least one patent claim.

44. The computer-implemented method of claim 23 wherein the creating of the patent search report comprises:
identifying a location of a disclosure in one or more reference documents retrieved from the searching of the at least one database using the patent-related information;
entering an explanation of patentability of at least one patent claim over the disclosure located in the one or more reference documents; and
showing of support for the at least one patent claim in a specification of the patent document.

45. The computer-implemented method of claim 44 wherein the showing of support comprises:
semantically indexing a plurality of textual paragraphs in the specification;
retrieving the semantically indexed textual paragraphs;
applying as a search query the at least one patent claim to the retrieved, semantically indexed textual paragraphs; and
generating a rank-ordered results list of the textual paragraphs most semantically related to the at least one patent claim.

46. The system of claim 42 wherein the case management subsystem is operative to enable an end-user to show support for the at least one patent claim with one or more annotations in the specification of the patent document.

47. The system of claim 44 wherein the case management subsystem is operative to enable an end-user to show support for the at least one patent claim with one or more annotations in the specification of the patent document.

48. A computer-readable medium having instructions stored thereon for performing the method of claim 1.
